(19) United States
(12) Patent Application Publication
(10) Pub. No.: US 2010/0045073 A1
(43) Pub. Date: Feb. 25, 2010

(54) BEAM, AND METHOD FOR MAKING SUCH BEAM

(76) Inventor: Torbjorn PEDERSEN, Raufoss (NO)

Correspondence Address: WENDEROTH, LIND & PONACK, L.L.P., 1030 15th Street, N.W.,, Suite 400 East, Washington, DC, 20005-1503, US

(21) Appl. No.: 12/606,370

(22) Filed: Oct. 27, 2009

Related U.S. Application Data
(63) Continuation of application No. 11/661,278, filed on Jun. 20, 2007.

(30) Foreign Application Priority Data
Aug. 27, 2004 (NO) 20043579
Aug. 24, 2005 (NO) PCT/NO2005/000307

(51) Int. Cl. B60R 19/00; B21D 53/88

(52) U.S. Cl. 296/205; 29/897.2

(57) ABSTRACT

An impact-absorbing member for impact protection of a vehicle made from a work piece including a hollow profile provided with walls and an inner space. At least a part of at least one wall of the profile is cut in such a way that it forms a lip. The lip is bent away from the wall thereby forming at least one additional reinforcing wall. A method for reinforcing an impact-absorbing member used in a vehicle includes making a cut in at least one section of a wall of a work piece thereby forming at least one lip, which is bent away from the wall thereby forming at least one additional reinforcing wall.

This application is a continuation of U.S. application Ser. No. 11/661,278, filed Feb. 27, 2007, the contents of which is fully incorporated herein by reference.

### BACKGROUND OF THE INVENTION

1. Field of the Invention

The present invention relates to an impact-absorbing member for impact protection of a vehicle where the impact-absorbing member is made from a work piece comprising a hollow profile having walls and an inner space and a method for reinforcing such impact absorbing member.

2. Description of Related Art

Impact beams for vehicles are known and are made in many different designs. Impact beams can for example be made from a hollow profile provided with at least two sidewalls and a front wall. In a crash situation, the walls will collapse following predetermined patterns in the profile of the sidewalls and thereby absorb a controllable amount of energy. Additionally, several chambers can be arranged in the length axis of the beam separated by internal walls in the beam to improve the energy absorption of the impact beam.

Such an impact beam is disclosed in EP 1015277 B1. The design is especially suitable for extruded profiles. The use of longitudinal chambers enables a design in which the same improved deformation pattern is obtained across the length of the beam. However, there is an increasing awareness of the fact that the impact behaviour of a vehicle demands a changing deformation performance along the length axis of a beam.

It is also known to produce crash boxes from extruded work pieces. An extruded blank is cut in smaller work pieces, the sidewalls of the work piece are then folded to form a box, and thereafter welded to the part of the work piece forming the end plate part. The crash boxes made by such a method have the same limitation in design as the beams described above. The sidewalls are folded during the production process and it is often necessary to perform extra forming or other processing steps to improve the deformation behaviour of the crash box. This can increase the plurality and complexity of the production steps in making a crash box and consequently results in high production costs.

### SUMMARY OF INVENTION

The object of the present invention is to present a method for producing impact beams or improving existing impact beams without the need of welding seams or complicated and expensive fabrication methods. It is also an object to present a method for locally enforcing an impact beam without modification of the overall structure of the beam. Furthermore, it is an object to present an impact beam, which is easy to construct, and which has an improved deformation performance.

These objects are met by cutting at least a part of a wall of a work piece in such a way that it forms a lip and where the lip is bent into the inner space of the work piece, thereby forming at least one additional reinforcing wall or protrusion.

### BRIEF DESCRIPTION OF DRAWINGS

The invention will now be further explained by figures where

FIGS. 1a and 1b are a top perspective view and a side view in section, respectively, of a first step in the process of forming a reinforcement lip in a work piece,

FIGS. 2a and 2b are a top perspective view and a side view in section, respectively, of a second step in the process of forming of a reinforcement lip in a work piece,

FIGS. 3a and 3b are a top perspective view and a side view in section, respectively, of a third step in the process of forming a reinforcement lip in a work piece,

FIGS. 4a and 4b are a top perspective view and an end view, respectively, of an optional fourth step in the process of forming a reinforcement lip in a work piece,

FIG. 5 is a perspective view of an embodiment of an impact-absorbing member provided with two lips,

FIG. 6 is a side view in section of the embodiment of FIG. 5 taken along lines A-A,

FIGS. 7a and 7b are a perspective view and a cross sectional view taken along line A-A, respectively, of a first embodiment of a beam provided with lips,

FIGS. 8a and 8b are a perspective view and a cross sectional view taken along line A-A, respectively, of a second embodiment of a beam provided with lips,

FIGS. 9a and 9b are a perspective view and a cross sectional view taken along line A-A, respectively, of a third embodiment of a beam provided with lips,

FIG. 10 illustrates a reinforced impact absorbing assembly.

### DETAILED DESCRIPTION OF THE INVENTION

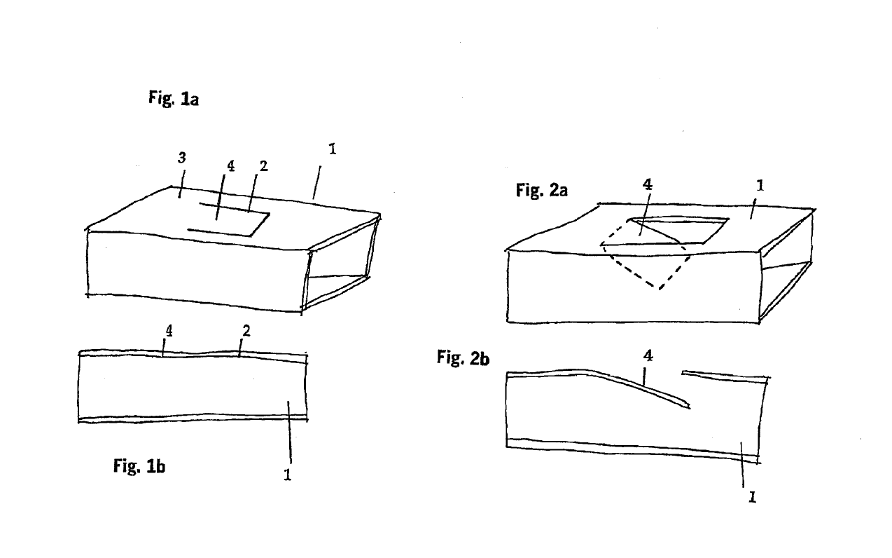

The present invention presents a simple and efficient method for the reinforcement of a work piece, preferably a hollow profile. FIGS. 1a and b show a first step in the process of forming a reinforcement lip in a work piece and FIG. 1a shows a work piece 1 in a perspective view. FIG. 1b shows the same work piece in a cross sectional side view. In this step, a cut is made in a wall 3 of the work piece 1. The cut 2 is made in such a way that it will form a lip 4 when the wall material inside the cut 2 is bent away from the wall surface. The cut can e.g. be made by cutting with a tool or by punching or stamping out a section of the wall.

FIGS. 2a and 2b show a second step in the process of forming a reinforcement lip in a work piece and FIG. 2a shows the work piece 1 in a perspective view during a forming operation. FIG. 2b shows the same work piece in a cross sectional side view. In this step, the lip 4 will normally be bent into the work piece 1.

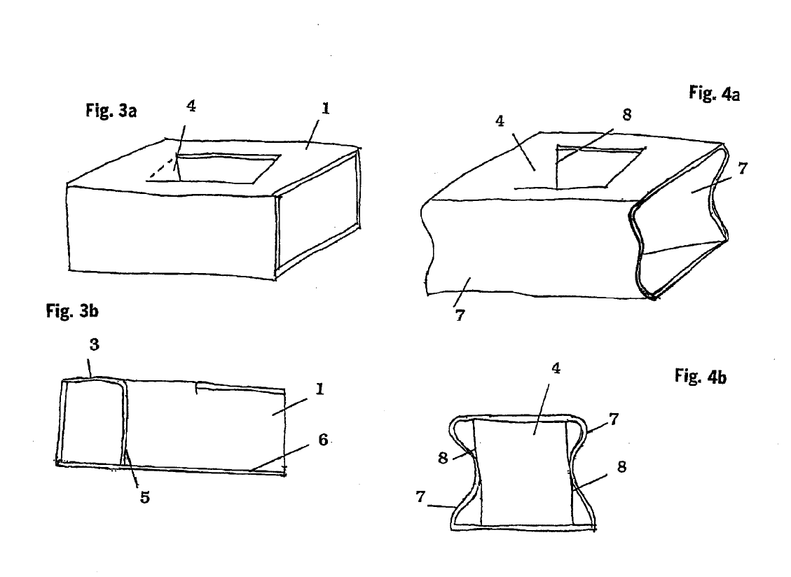

FIGS. 3a and 3b show a third step in the process of forming a reinforcement lip in a work piece. FIG. 3a shows the work piece 1 with a lip 4 in a perspective view and FIG. 3b shows the same work piece 1 in a cross sectional side view. The cut can be made in such a way that the lip end section 5 will be fixed inside the work piece 1 by being bent into contact with an opposing inner surface 6 of a wall. In the present examples, the lip is bent until it is situated perpendicular to the wall 3 from which it is bent.

The cutting and bending operation can also be made in one single step. One or more lips can be punched out from one or more walls and simultaneously bent away from the wall surface.

FIGS. 4a and 4b show an optional fourth step in the process of forming a reinforcement lip in a work piece. As an additional operation, the sidewalls 7 perpendicular to the wall being cut can be pressed inwards against the side edges 8 of the lip 4. This is shown on FIG. 4a in a perspective view and in FIG. 4b in a end view of a work piece. The forming operation stabilizes the lip 4 in its final position. The lip can also be fixed by any other method found suitable, such as welding, soldering, brazing, gluing or shaping of the work piece walls in any way fixing the lip in position.

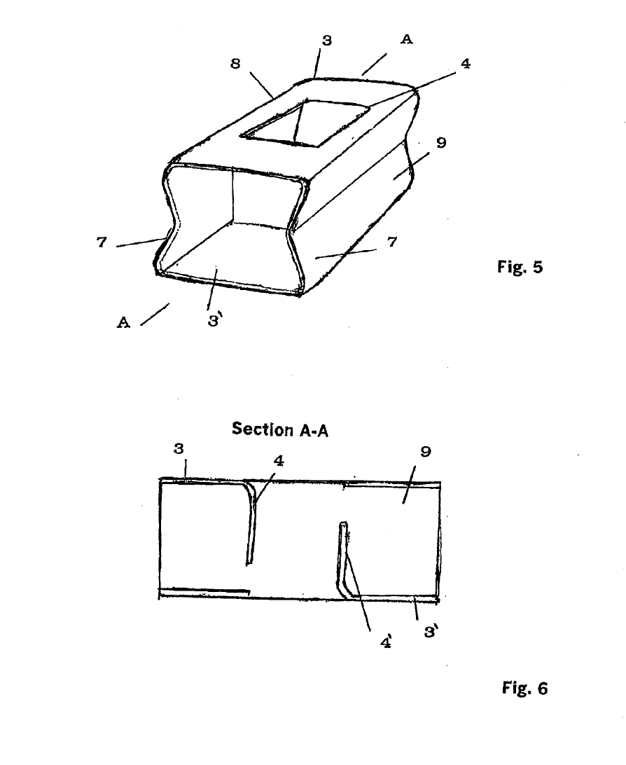

FIGS. 5 and 6 show a second embodiment of an impact-absorbing member 9 provided with two lips 4 and 4′ in a perspective view and a cross sectional side view, respectively. The lips 4, 4′ are cut in two walls 3, 3′ opposing each other. The lips are thereafter bent in such a way that they will form two inner walls opposing each other. The sidewalls 7 of the impact-absorbing member can thereafter be pressed into contact with the side edges 8 of the lips 4 and 4′, thereby fixing the lips inside the impact-absorbing member 9.

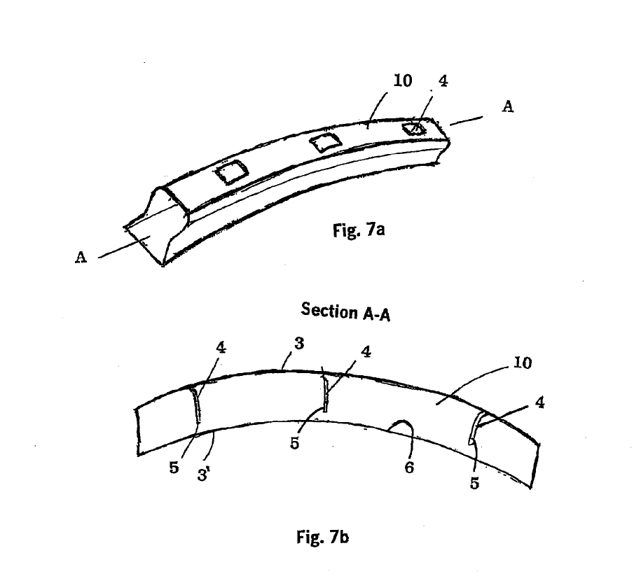

FIG. 7a shows a perspective view of a beam 10 provided with lips 4. The lips 4 can be made anywhere on the beam 10. There can be as many lips in the beam as found suitable for the beam being designed. FIG. 7b shows the same beam 10 in a cross sectional side view. In the present example, the lips 4 are cut and bent in such a way that they form inner sidewalls in the beam. These sidewalls can reach from the wall 3 being cut and bent down to the inner surface 6 of the opposing wall 3′ or as in the present example leave space between the lip end section 5 and the inner surface 6.

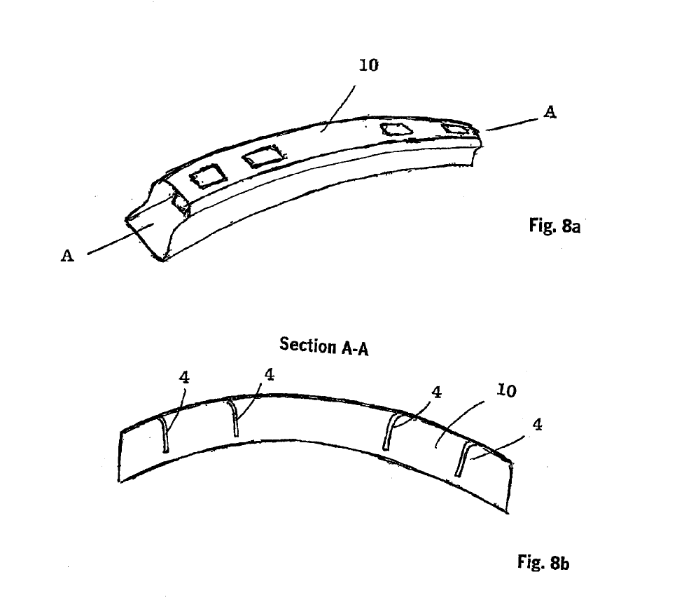

FIG. 8a shows a perspective view of a second embodiment of a beam 10 provided with lips. FIG. 8b shows the same beam 10 in a cross sectional side view. The lips 4 can be formed in regions of the beam. It is known that some areas of a vehicle are more subjected to impact than others. By enforcing the most exposed regions of a beam, it is possible to design a more adapted impact protection of the vehicle and passengers.

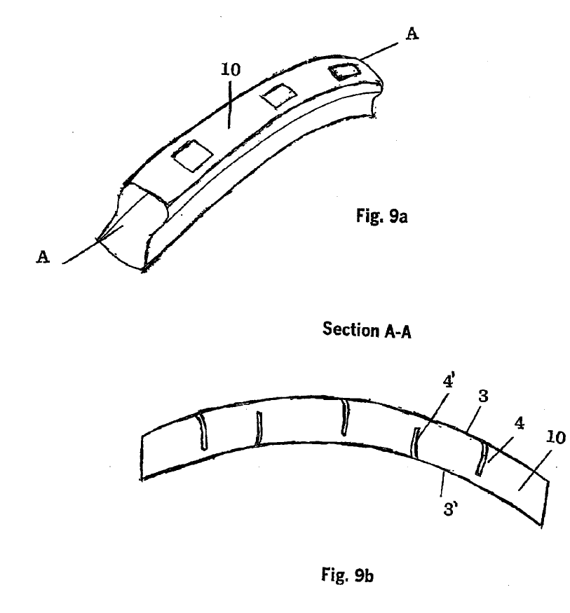

FIG. 9a shows a perspective view of a third embodiment of a beam and FIG. 9b shows the same beam in a cross sectional side view. The beam 10 is provided with lips 4 that are made in two opposing walls 3, 3′. The lips can be made in any wall of a beam. Even if the lips made in the present examples are symmetrically situated on the beam, it is obvious that this is no limitation to where the lips can be made. If this is found suitable, lips can be made in every wall of the beam.

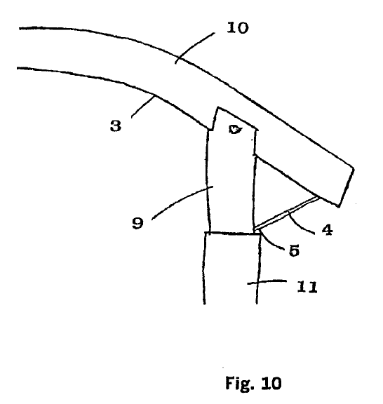

FIG. 10 shows a reinforced impact absorbing assembly. In the vehicle body, side frames 11 are arranged along the length of the vehicle. On the end section of the side frame 11, an impact-absorbing member 9 can be attached to the side frame as an intermediate member between the side frames 11 and a transversal frontal or rear beam 10. The impact-absorbing member 9 will be attached to the end sections of the beam 10.

It can be found suitable to reinforce the frontal or rear side regions of a vehicle to improve the crash performance if the vehicle gets an impact here. This can be done by cutting a lip 4 in the rear wall 3 of the beam. The lip 4 is folded out from the rear wall until the lip end section 5 can be fixed to the impact-absorbing member 9. The lip end section can be fixed to the impact-absorbing member by friction as it is pressed against the member or welded, glued or otherwise mechanically attached to the member.

If the transversal beam is attached directly to the side frame, a lip can be cut in a wall of the beam in such a way that the lip can be folded and fixed to the side frame, thereby reinforcing the side region of the vehicle.

The invention is particularly convenient for the use in impact absorbing members in a vehicle. The invention can be used in crash boxes, transversal beams, side beams or in any other beam subjected to deformation.

The work piece can be made of aluminium or an aluminium alloy, for example as an extruded profile. It is also possible to use the method for members being made from steel members made by rolling or any other method common in the steel processing industry. The method can even be useful in polymer members. The forming operation according to the present invention can be combined with a heat treatment of the work piece.

Even if the present invention is used on closed hollow profiles, it can also be used on open profiles where the lips form an additional reinforcement of the existing walls. The invention can also be used to reinforce members, which will be filled with a second material after the forming operation, such as foam made of polymers or aluminium.

1-10. (canceled)

11. An impact absorbing member for impact protection of a vehicle, the impact-absorbing member being made from a work piece, said impact absorbing member comprising:
a hollow profile having a first wall, a second wall opposing said first wall, and at least one side wall, said first wall, said second wall and said at least one side wall defining an inner space; and
a lip being cut from at least a part of said first wall, and being configured such that said lip extends perpendicularly from said first wall into the inner space toward said second wall, and extending perpendicularly to said at least one side wall, said lip forming an internal wall in said hollow profile.

12. An impact absorbing member according to claim 11, wherein said lip has a lip end section that abuts said second wall.

13. An impact absorbing member according to claim 11, wherein said at least one side wall being pressed into contact with an edge of said lip when said lip is situated inside the inner space of said hollow profile.

14. An impact absorbing member according to claim 11, wherein the work piece is formed from aluminium or an aluminium alloy.

15. An impact absorbing member according to claim 11, wherein said hollow profile is made from an extruded blank.

16. A method for reinforcing an impact-absorbing member used in a vehicle, the member being made from a work piece, the method comprising:
providing a hollow profile having a first wall, a second wall opposing the first wall, and at least one side wall, the first wall, the second wall and the at least one side wall defining an inner space,
forming at least one lip by making a cut in at least one section of the first wall, and bending the lip inside the hollow profile, such that the lip extends perpendicularly from the first wall into the inner space toward the second wall, and extends perpendicularly to the at least one side wall, and forms an internal wall in the hollow profile.

17. A method according to claim 16, further comprising: fixing the lip inside the hollow profile after said bending.

18. Method-according to claim 16, wherein the work piece is formed from an extruded blank, which is cut into smaller work pieces.

19. An impact absorbing member according to claim 11, wherein said impact absorbing member also comprising a second side wall opposing the at least one side wall.
